(19) United States
(12) Patent Application Publication
(10) Pub. No.: US 2011/0181026 A1
(43) Pub. Date: Jul. 28, 2011

(54) JOINT ASSEMBLY WITH SAFETY LOCKING MECHANISMS FOR BABY STROLLER

(75) Inventors: Chuan-Ming Yeh, Chuayi City (TW); Chen-Tai Chang, Chiayi County (TW); Fu-Peng Chou, Taichung City (TW)

(73) Assignee: LERADO (ZHONG SHAN) INDUSTRIAL CO., LTD, Guang Dong Province (CN)

(21) Appl. No.: 13/015,653

(22) Filed: Jan. 28, 2011

(30) Foreign Application Priority Data
Jan. 28, 2010 (CN) 201020108502.3

(51) Int. Cl. B62B 7/06

(52) U.S. Cl. 280/650

(57) ABSTRACT

A joint assembly with safety locking mechanisms for baby stroller, the baby stroller frame may have at least a front strut, a rear strut and an upper bar; and the joint assembly includes a lower joint member, an upper joint member, a first locking mechanism, a second locking mechanism and a release mechanism. The lower joint member is pivotally connected with the upper end of the front strut and pivots with the rear strut through a pivot mount atop the rear strut. The upper joint member pivots with the lower joint member and connects with the lower end of the upper bar. The first locking mechanism is adapted to releasably lock the lower joint member to the upper joint member thereby to inhibit the potential relative rotation between the lower joint member and the upper joint member. The second locking mechanism is adapted to releasably lock the rear strut to the joint assembly thereby to inhibit the potential relative rotation between the rear strut and the joint assembly. Therefore, the locking mechanisms according to the present invention within the joint assembly can effectively inhibit the gap from biting or pinching the occupant's fingers.

### CROSS-REFERENCE TO RELATED APPLICATION

This non-provisional application claims priority under 35 U.S.C. §119(a) on Patent Application No(s). 201020108502.3 filed in People's Republic of China. on Jan. 28, 2010, the entire contents of which are hereby incorporated by reference.

### BACKGROUND OF THE INVENTION

1. Field of the Invention

The present invention relates generally to a joint assembly with safety locking mechanisms for baby stroller that can help inhibit the relative rotations between the struts and upper bar of a baby stroller, so as to prevent the occupant's finger accidentally pinched by the joint assembly while the upper bar is lifting upward or pressing downward as the user is trying to pass over an obstacle on the road.

2. Description of the Related Art

Joint assembly is normally installed on a collapsible stroller, that can pivotally connect the front strut, the rear strut and the upper bar. Traditional Joint assembly includes a lower joint member and an upper joint member, which can be locked as the collapsible stroller is deployed in in-use position, and can be unlocked to permit the relative rotation between the front strut, the rear strut and the upper bar thereby to fold the collapsible stroller in a storage configuration.

In order to reserve enough space within the joint assembly for allowing the rotations between distal ends of the front strut, the rear strut and the upper bar, would cause a gap therebetween. When a user is trying to move the stroller pass over an obstacle, the upper bar may be lifting upward or pressing downward and make the gap to enlarge and close repeatedly, just like biting neb or a chewing mouth, that can pinch and endanger the occupant's finger accidently.

### SUMMARY OF THE INVENTION

To solve such a finger-pinch problem, the present invention provides a joint assembly with safety locking mechanisms for baby stroller. The baby stroller frame may have at least a front strut, a rear strut and an upper bar; and the joint assembly includes a lower joint member, an upper joint member, a first locking mechanism, a second locking mechanism and a release mechanism. The lower joint member is pivotally connected with the upper end of the front strut and pivots with the rear strut through a pivot mount atop the rear strut. The upper joint member pivots with the lower joint member and connects with the lower end of the upper bar. The first locking mechanism is adapted to releasably lock the lower joint member to the upper joint member thereby to inhibit the potential relative rotation between the lower joint member and the upper joint member. The second locking mechanism is adapted to releasably lock the rear strut to the joint assembly thereby to inhibit the potential relative rotation between the rear strut and the joint assembly. The release mechanism is adapted to unlock the first locking mechanism and the second locking mechanism. In other words, the locking mechanisms according to the present invention in the joint assembly can inhibit the gap from biting or pinching the occupant's fingers.

### BRIEF DESCRIPTION OF THE DRAWINGS

The accompanying drawings, which are included to provide a further understanding of the invention are incorporated in and constitute a part of this specification, illustrate embodiments of the invention and together with the description serve to explain the principles of the invention. In the drawings:

FIG. 1 is a side view schematically depicts an embodiment of the joint assembly according to the present invention applied on a baby stroller frame.

FIG. 2 is a rear view illustrating the back portion of the baby stroller frame.

FIG. 3 is an exploded view showing the embodiment of the joint assembly with safety locking mechanisms according to the present invention.

FIG. 4 is an enlarged cross-sectional view schematically depicts the joint assembly with safety locking mechanisms being kept in a locked position.

FIG. 5 is another enlarged cross-sectional view schematically depicts the operation for unlocking the joint assembly in the locked position.

FIG. 6 is an enlarged cross-sectional view schematically depicts the joint assembly with safety locking mechanisms in an unlocked position.

FIG. 7 is a side view schematically depicts another embodiment of the joint assembly according to the present invention applied on a baby stroller frame.

FIG. 8 is an enlarged cross-sectional view schematically depicts the first safety locking mechanisms of the joint assembly being kept in a locked position.

FIG. 9 is an enlarged cross-sectional view schematically depicts the operation for unlocking the second safety locking mechanisms of the joint assembly.

### DETAILED DESCRIPTION OF THE PREFERRED EMBODIMENTS

Reference will now be made in detail to the preferred embodiments of the present invention; examples of which are illustrated in the accompanying drawings.

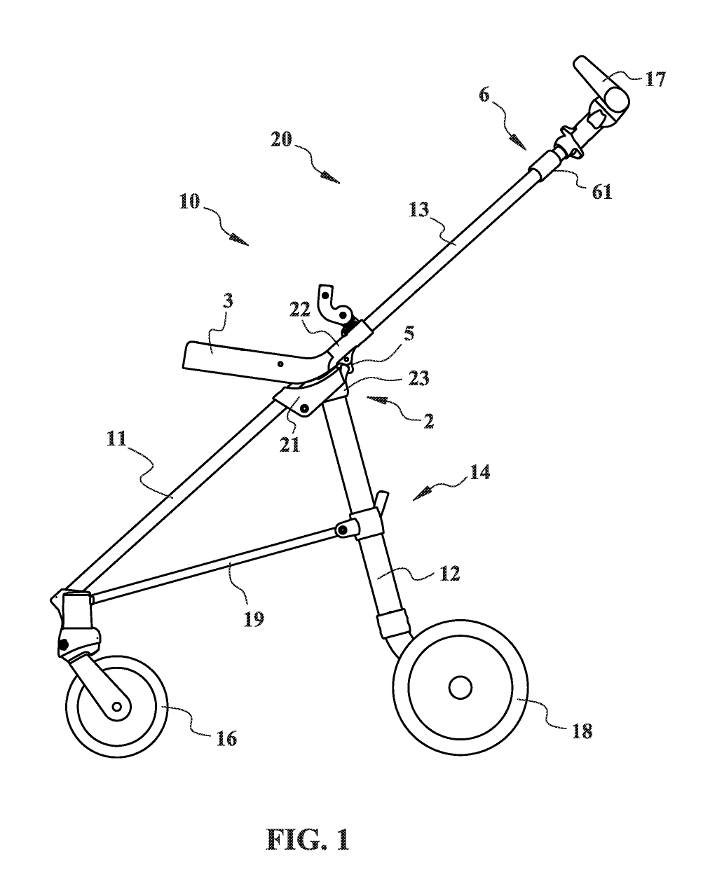

Referring to FIGS. 1 to 6, an embodiment of the joint assembly 2 with safety locking mechanisms 4, 5 according to the present invention is operatively mounted on a baby stroller frame 10. The baby stroller frame 10 has typically at least a front strut 11, a pair of rear struts 12 and an upper bar 13 pivotally connected with the joint assembly 2.

Referring to FIG. 1, a link bar 19 is linked between the front strut 11 and the rear strut 12 for limiting the open angle between the front strut 11 and the rear strut 12; further, a front wheel 16 and at least two rear wheels 18 are connected at the lower end of the front strut 11 and the pair of rear struts 12, for supporting such a stroller in an used position 20 as being shown.

The joint assembly 2 is lockable and used to pivotally interconnect the front strut 11, the rear strut 12 and the upper bar 13. A pair of armrest 3 may further be pivotally mounted on the joint assembly 2 at both side of the baby stroller frame 10.

The upper bar 13 has a gripable portion 17 at the upper end thereof, for pushing and steering the baby stroller frame 10 while in use.

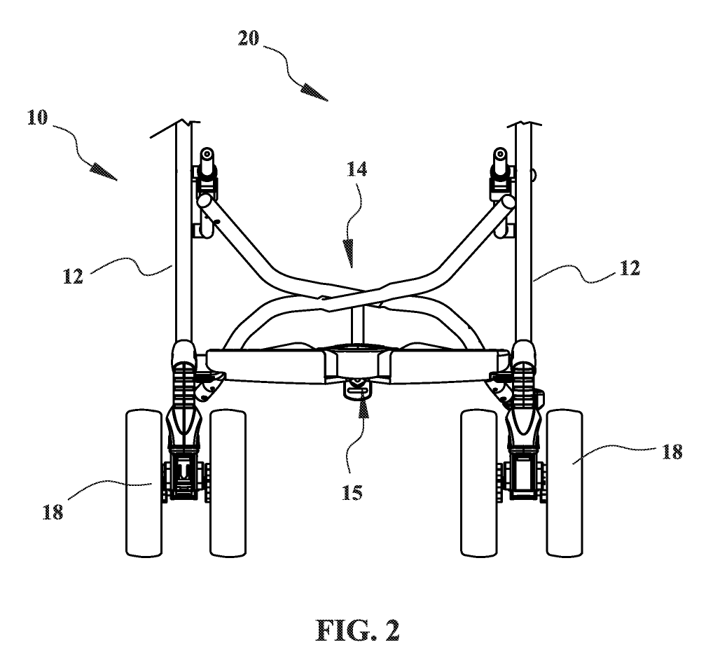

Referring to FIG. 2, a cross-bar mechanism 14 is operatively interconnected the pair of rear struts 12 for carrying the rear struts 12 to extend laterally and kept in the in-use position 20, and close to each other when folding the baby stroller frame 10 by stepping down a pedal 15.

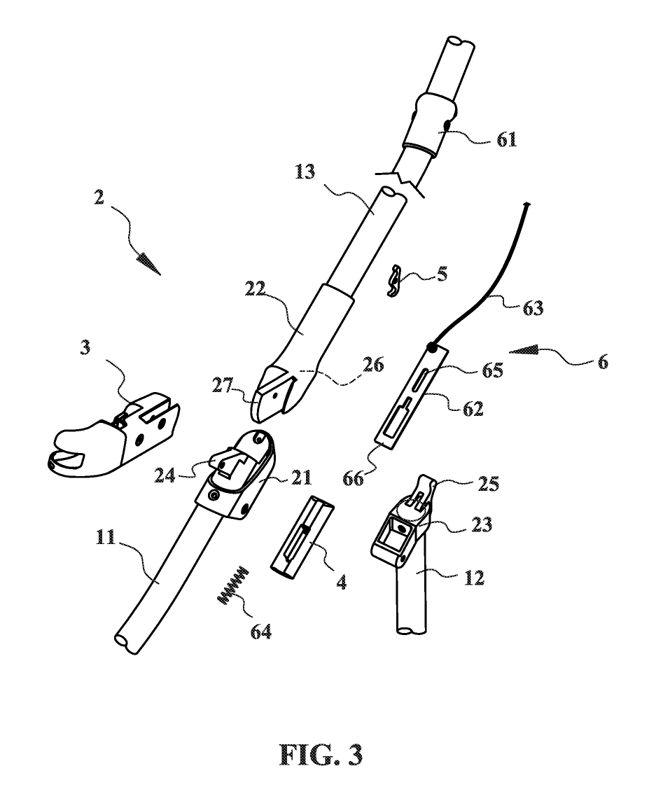

Referring to FIG. 3, the joint assembly 2 includes a lower joint member 21, an upper joint member 22, a first locking mechanism 4, a second locking mechanism 5 and a release mechanism 6.

The lower joint member 21 is pivotally connected with the upper end of the front strut 11 and pivots with the rear strut 12 through a pivot mount 23 which mounted atop the rear strut 12. The upper joint member 22 pivots with the lower joint member 21 and connects with the lower end of the upper bar 13.

Preferably, the lower joint member 21 may be formed with a pivot portion 24 for pivoting with the armrest 3, the upper joint member 22 and the rear strut 12; also, the upper joint member 22 may be formed with an extended pivot portion 27 for pivoting with the lower joint member 21 thereby to permit the front strut 11, a rear strut 12 and an upper bar 13 to be rotatable relative to each other.

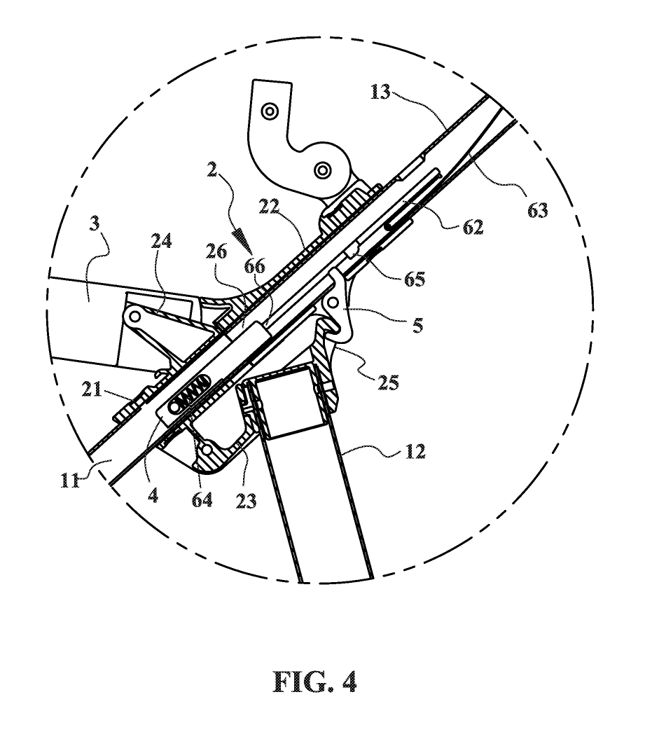

Referring to FIGS. 3 and 4, the first locking mechanism 4 is adapted to releasably lock the lower joint member 21 to the upper joint member 22 thereby to inhibit the potential relative rotation between the lower joint member 21 and the upper joint member 22. The second locking mechanism 5 is adapted to releasably lock the rear strut 12 to the joint assembly 2 thereby to inhibit the potential relative rotation between the rear strut 12 and the joint assembly 2.

The first locking mechanism 4 may be embodied as a pin which retractably installed within the lower joint member 21 and biased by a resilient element 64 toward an engagement portion 26 formed within the upper joint member 22. The engagement portion 26 may be embodied as a hole or the central hole of the distal end of the upper bar 13.

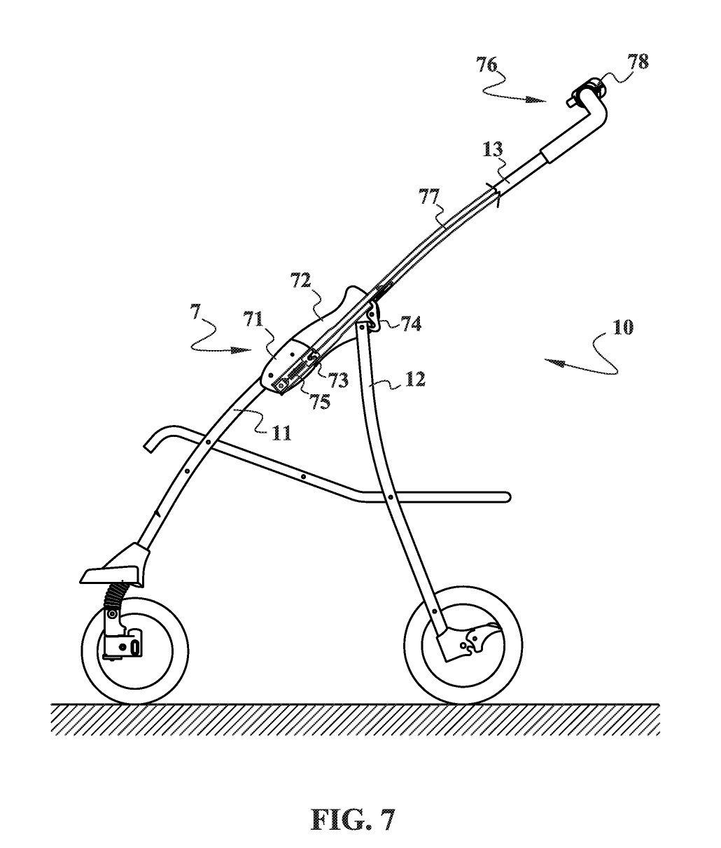

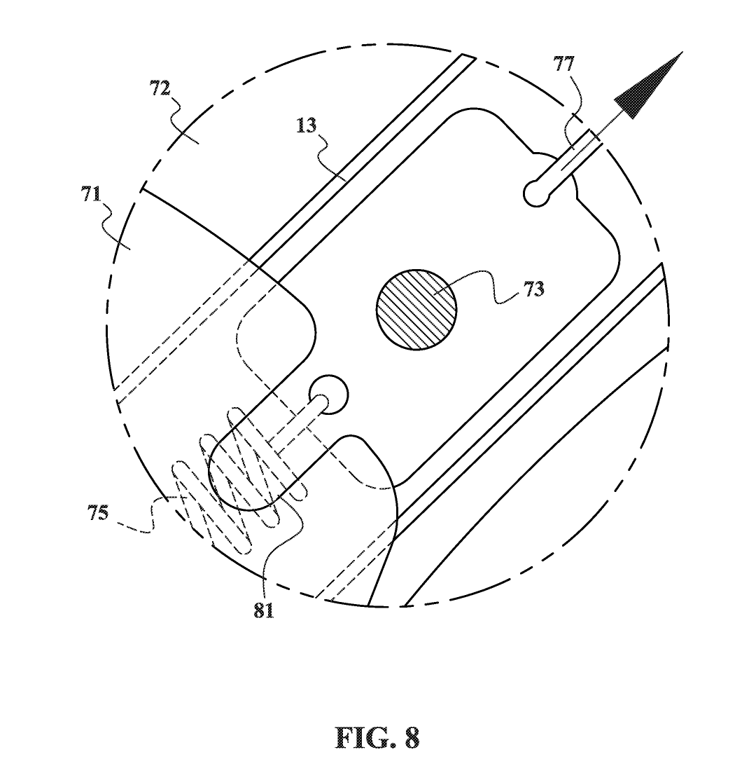

However, first locking mechanism may also be embodied as a pin 73 which may be movably installed within the upper joint member 72 as shown in FIGS. 7 and 8, and the engagement portion may be embodied as an indent 81 formed on the upper end of the lower joint member 71. The pin 73 is kept by a resilient element 75 so as to engage within the indent 81 to inhibit the rotation between the front strut 11 and the upper bar 13 thereby to keep the baby stroller frame 10 in the in-use position 20. When need to fold the baby stroller frame 10 to a storage configuration, the pin 73 (first locking mechanism) can be pulled apart from the indent 81 (the engagement portion) by a connected element 77 of the release mechanism 76. The release mechanism 76 may be installed on or near the gripable portion 78 for unlocking the joint assembly 7 remotely.

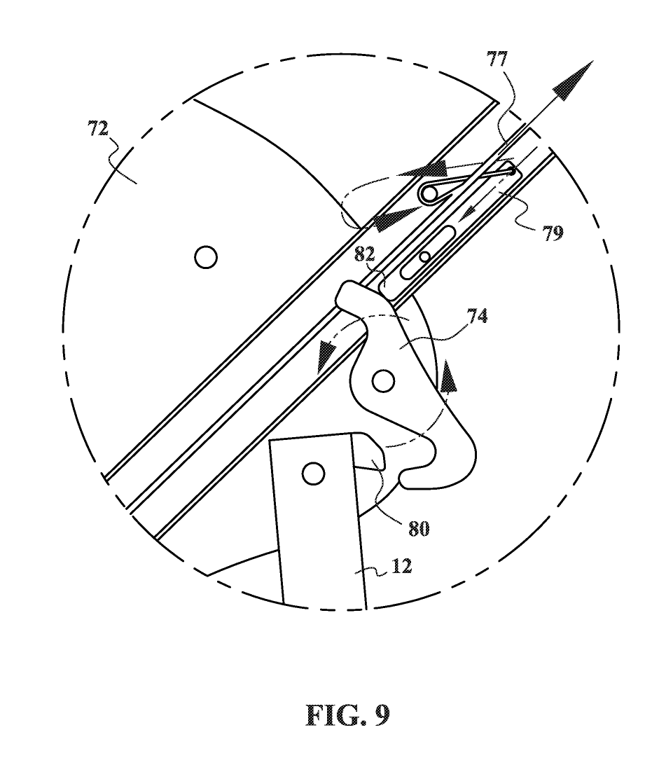

Referring back to FIGS. 4 to 6, the second locking mechanism 5 may include a spring-biased hooked element, and the rear strut 12 may have a dented portion 25, hook-like protruded portion or the like, for facilitating a snap-engagement with such a spring-biased hooked element. Preferably, the dented portion 25 is formed on the pivot mount 23 by an injecting mold. Further, the dented portion 25 can be instead of a hook-like protruded portion 80 protruded near the top of the rear strut 12 as shown in FIG. 9 for providing a snap-engagement with the second locking mechanism 74 (in this embodiment, it is a spring-biased hooked element).

Referring to FIGS. 1, 4, 8 and 9, the release mechanism 6, 76 can be adapted to unlock the first locking mechanism 4, 73 and the second locking mechanism 5, 74, which comprises at least an actuator 61, a sliding element 62 and a connecting element 63.

The actuator 61 may be embodied as a slider or handle mounted on the upper bar 13 near the gripable portion 17, 78;

The sliding element 62, 82 is reciprocally mounted in the upper joint member 22, 72 associating with the actuator 61 by a connecting element 63, 77 for unlocking the first locking mechanism 4, 73 and the second locking mechanism 5, 74 simultaneously.

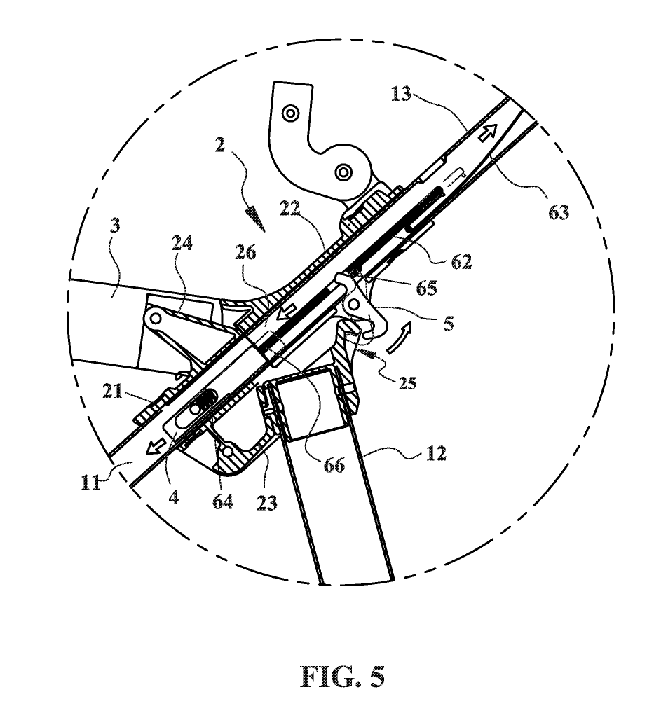

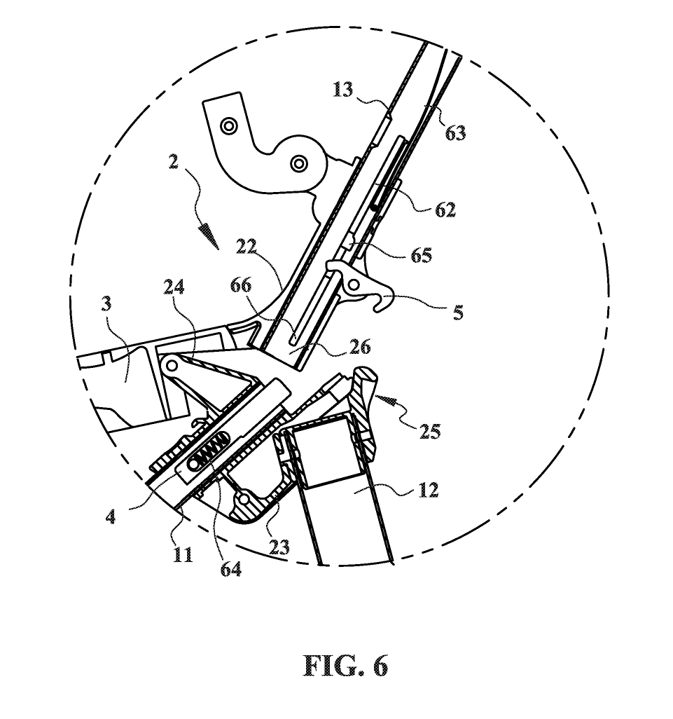

The connecting element 63 is applied for associating the actuator 61 and the sliding element 62, and may be a flexible wire for driving the sliding element 62 so as to push the first locking mechanism 4 to a retracted position as being schematically depicted in FIGS. 5 and 6, or to pull the first locking mechanism 73 to a retracted position as being schematically depicted in FIG. 8

The sliding element 62 as shown in FIGS. 3 to 6, may have an abutment end 66 for abutting or pushing the first locking mechanism 4 away from the engagement portion 26 to a retracted position. Preferably, the sliding element 62 as shown in FIGS. 3 to 6, may be formed with a slot which has at least one edge 65 for rotating the spring biased hooked element (the second locking mechanism 5, 74) so as to unlock the second locking mechanism 5, 74. In the same way, the embodiment of sliding element 79 as shown in FIGS. 9 may also provided with an edge 82 for rotating the spring biased hooked element so as to unlock the second locking mechanism 74.

As the locking mechanism 4, 5, 73 and 74 can effectively inhibit the relative rotation of the struts 11 and 12 and the upper bar 13 around joint assembly 2, 7, it means that the present invention can avoid the occupant's fingers from biting or pinching by the gap, while the user is lifting or pressing the upper bar 13 to pass an obstacle.

While particular embodiments of the invention have been described, those skilled in the art will recognize that many modifications are possible that will achieve the same goals by substantially the same system, device or method, and where those systems, devices or methods still fall within the true spirit and scope of the invention disclosed.

What is claimed is:

1. A joint assembly with safety locking mechanisms for baby stroller, the baby stroller frame has at least a front strut, a rear strut and an upper bar, and the joint assembly including:
a lower joint member, connected with the upper end of the front strut and pivoted with the rear strut through a pivot mount mounted atop the rear strut;
an upper joint member, pivoted with the lower joint member and connected with the lower end of the upper bar;
a first locking mechanism, for releasably locking the lower joint member to the upper joint member thereby to stop the relative rotation between the lower joint member and the upper joint member;
a second locking mechanism for releasably locking the rear strut to the joint assembly thereby to stop the relative rotation between the rear strut and the joint assembly;
a release mechanism for unlocking the first locking mechanism and the second locking mechanism simultaneously thereby to permit the baby stroller frame to be folded from an in-use position to a folded position.

2. The joint assembly with safety locking mechanisms for baby stroller of claim 1, wherein the first locking mechanism includes a spring-biased hooked element, and the pivot mount has a dented portion for facilitating a snap-engagement with the spring-biased hooked element.

3. The joint assembly with safety locking mechanisms for baby stroller of claim 1, wherein the first locking mechanism includes a spring-biased retractable element for latching into an engagement portion formed in the upper joint member.

4. The joint assembly with safety locking mechanisms for baby stroller of claim 1, wherein the upper joint member has an extended pivot portion for pivoting with the lower joint member thereby to permit the front strut, the rear strut and the upper bar to be rotatable relative to each other.

5. The joint assembly with safety locking mechanisms for baby stroller of claim 1, wherein the lower joint member has a pivot portion to which an armrest pivoted thereon.

6. The joint assembly with safety locking mechanisms for baby stroller of claim 1, wherein the first locking mechanism is a pin biased by a resilient element toward an indent formed atop the lower joint member thereby to stop the rotation between the lower joint member and the upper joint member.

7. The joint assembly with safety locking mechanisms for baby stroller of claim 6, wherein the first locking mechanism is a spring-biased hooked element pivoted on the upper bar, and the rear strut has a hook-like portion 80 for facilitating a snap-engagement with said spring-biased hooked element.

8. The joint assembly with safety locking mechanisms for baby stroller of claim 1, wherein the release mechanism comprising:
an actuator 61 operatably mounted on the upper bar;
a sliding element for unlocking the first locking mechanism and the second locking mechanism; and
a connecting element for associating the actuator and the sliding element.

9. The joint assembly with safety locking mechanisms for baby stroller of claim 8, wherein the connecting element is a flexible wire for driving the sliding element to push the first locking mechanism to a retracted position, and rotate the second locking mechanism to an unlocked position simultaneously.

10. The joint assembly with safety locking mechanisms for baby stroller of claim 8, wherein the sliding element is formed with a slot which has at least one edge for rotating and releasing the second locking mechanism.
